(19) United States
(12) Patent Application Publication
(10) Pub. No.: US 2010/0040314 A1
(43) Pub. Date: Feb. 18, 2010

(54) Linear Guideway

(76) Inventors: Ming-Yao Lin, Taichung (TW); Yun-Yi Lin, Taichung (TW)

Correspondence Address: Dr. BANGER SHIA, 102 Lindencrest Ct., Sugar Land, TX, 77479-5201, US

(21) Appl. No.: 12/193,041

(22) Filed: Aug. 17, 2008

(51) Int. Cl. F16C 29/06

(52) U.S. Cl. 384/44

(57) ABSTRACT

A linear guideway essentially comprises plural bolt-hole covers, and each of the bolt-hole covers essentially includes a main body and an elastic part. The main boy includes a cover plate and a positioning portion. The periphery of the positioning portion is provided with a guiding portion and a groove, and the positioning portion is provided with plural cutting grooves vertical to the cover plate for offering flexibility to the positioning portion. The elastic part is installed in the groove of the positioning portion. With the elastic functions of the positioning portion and the elastic part, the bolt-hole cover can be fixed in the bolt hole more stably through the interference with the bolt hole.

### BACKGROUND OF THE INVENTION

1. Field of the Invention

The present invention relates to a linear guideway, and more particularly to a bolt-hole cover for a linear guideway.

2. Description of the Prior Art

In order to be fixed on a machine, conventional linear guideways are commonly provided with plural equally-spaced bolt holes in the slide rails for screw connection. The bolt hole must be in the formed of a stepped countersink, so that the head of a screw will lie below the upper surface of the guideway for avoiding affecting the movement of the slide block. After the guideway is locked on the machine, the head of the screw and the upper surface of the slide rail will define a groove therebetween, so that dust or foreign bodies are likely to fall off into the groove and then affect the operation of the slide block. For avoiding the occurrence of such a problem, the conventional method is to provide a bolt-hole cover on the bolt hole and there are two common conventional technologies described below.

The first common conventional technology relates to a bolt-hole cover 6 disclosed in Taiwan Pat No. 525724, as shown in FIG. 7, and the bolt-hole cover 6 is disc-shaped and centrally provided with an air hole 61 for discharge of the air when the bolt hole cover 6 is knocked into the bolt hole. In addition, the bolt-hole cover 6 is provided with a ring-shaped part 62 at the periphery thereof. The outer surface of the ring-shaped part 62 is provided with a cone-shaped guiding portion 63 for facilitation of knocking the bolt-hole cover 6 in a bolt hole.

The second conventional technology relates to a bolt-hole cover 7 disclosed in JP Pat No. 2007-196682, as shown in FIG. 8, and the bolt-hole cover 7 comprises a top plate part 71 formed of a cover portion 711 and an engaging portion 712 extending from the top plate part 71 downward. The outer diameter D7 of the engaging portion 712 is bigger than the outer diameter D8 of the cover portion 711, and between the cover portion 711 and the engaging portion 712 is provided a groove portion 713. In addition, the engaging portion 712 includes a guiding portion 714 at a front end thereof.

The above two conventional technologies both utilize the periphery of the bolt-hole cover to contact the bolt hole of the slide block interferingly, and since the periphery of each of the bolt hole covers is not designed to be flexible, the force of the bolt-hole cover interfering with the bolt hole is fixed. Therefore, if the respective bolt-hole covers are subjected to vibration or external extrusion, they are likely disengage from their original positions, thus losing the predetermined function. In addition, since the periphery of each of the bolt-hole covers is lack of flexibility, when being combined to the bolt hole, the bolt-hole cover cannot absorb the machining error of the bolt hole.

The present invention has arisen to mitigate and/or obviate the afore-described disadvantages.

### SUMMARY OF THE INVENTION

The primary objective of the present invention is to provide a bolt-hole cover, utilizing two materials with different elastic coefficients to offer a function of flexibility to the periphery thereof.

In order to achieve the above objective, a linear guideway in accordance with the present invention comprises:

A slide rail is elongated and provided with two rolling channels at each of two sides thereof and plural bolt holes.

A slide block is movably mounted on the slide rail and is interiorly provided with rolling grooves opposite to the rolling channels.

Plural rolling elements are arranged between the rolling channels and the rolling grooves.

Two circulation members are arranged at two ends of the slide block and each provided with four circulating grooves for infinite circulation of the rolling elements.

Plural bolts are inserted in the bolt holes.

Plural bolt-hole covers each essentially include a main body and an elastic part. The main body includes a cover plate and a positioning portion. The positioning portion is arranged under the cover plate, and the elastic part is mounted on the positioning portion. The elastic coefficient of the elastic part is smaller than that of main body (note: according to Hooke's law: F=kx wherein: F represents the external force, k represents the elastic coefficient, x represents the deformation, under the action of the same external force, the smaller the elastic coefficient k is, the bigger the deformation x is, therefore, in order to match the elastic part with the bolt hole easily, the elastic part is designed to have an elastic coefficient smaller than that of the main body, so as to make the deformation of the elastic part bigger than that of the main body), the outer diameter of the elastic part which is not fitted into the bolt hole is bigger than the inner diameter of the bolt hole. The cover plate is provided with a through hole. The periphery of the positioning portion is provided with a guiding portion and a groove, and the positioning portion is further provided with plural cutting grooves vertical to the cover plate for offering flexibility to the positioning portion.

The elastic part is installed in the groove of the positioning portion and the elastic coefficient of the elastic part is smaller than that of the main body. The elastic part can be made of a material selected form the group consisting of rubber, silica gel, thermoplastic elastomer and a soft enough metal material (such as: copper or aluminum) for making the elastic coefficient thereof smaller than that of the main body. Besides utilizing the characteristic of the material to make the elastic coefficient thereof smaller than that of main body, the elastic part can also utilize the shape change to have the smaller elastic coefficient than the main body (note: if the elastic part is made of a material with higher Young's modulus, the change of the shape will be used to increase the deformation of the elastic part, for example, the C-shaped buckle with an opening is used as the elastic part, because of the opening, the C-shaped buckle has two free ends, so that under the action of the same external force, the deformation of the C-shaped buckle is quite bigger than that of the main body due to the structural factor, even though the Young' module of the main body is relatively smaller than that of the elastic part, based on the Hook' Law: F=kx (F represents external force; k represents elastic coefficient; and x represents deformation, it can be found that the elastic coefficient of the C-shaped buckle is smaller than that of the main body), and make the elastic part produce a radial force to cause the interference with the bolt hole.

In addition, the elastic part can be integrally formed on the main body by dual material molding, so that the installation time of the bolt-hole cover can be shortened and the fabrication cost is reduced.

The respective bolt-hole covers essentially have three outer diameters: the first is the outer diameter of the cover plate, the second is the outer diameter of the positioning portion, and the third is the outer diameter of the elastic part. The relation of the three outer diameters to the inner diameter of the bolt hole is described below: the outer diameter of the cover plate is equal to the inner diameter of the bolt hole, the outer diameter of the cover plate and the inner diameter of the bolt hole are both smaller than the outer diameter of the positioning portion, and the outer diameter of the positioning portion is smaller than the outer diameter of the elastic part, in other words, the outer diameter of the positioning portion is bigger than the outer diameter of the cover plate and the inner diameter of the bolt hole and smaller than the outer diameter of the elastic part. By such arrangements, with the elastic functions of the elastic part and the positioning portion, the bolt-hole cover can be fixed in the bolt hole in an interference manner for preventing the bolt-hole cover from losing the dust-proof function due to disengaging from the original position.

### BRIEF DESCRIPTION OF THE DRAWINGS

FIG. 1 is an exploded view of a linear guideway in accordance with the present invention;

FIG. 2 is a perspective view illustrating how a bolt-hole cover is matched with a bolt hole of the linear guideway in accordance with the present invention;

FIG. 3A is a top view of the bolt-hole cover in accordance with the present invention;

FIG. 3B is a cross-sectional view of the bolt-hole cover installed with an elastic part along the line A-A of FIG. 3A in accordance with the present invention;

FIG. 3C is a cross-sectional view of the bolt-hole cover installed with two elastic parts along the line A-A of FIG. 3A in accordance with the present invention;

FIG. 4A is a cross-sectional view illustrating how the bolt-hole cover is matched with the bolt hole of the linear guideway in accordance with the present invention;

FIG. 4B is a cross-sectional view illustrating that the bolt-hole cover is installed in the bolt hole in accordance with the present invention;

FIG. 5 is a perspective view of the bolt-hole cover in accordance with the present invention;

FIG. 6A is another top view of the bolt-hole cover in accordance with the present invention;

FIG. 6B is a cross-sectional view of the bolt-hole cover installed with an elastic part along the line B-B of FIG. 6A;

FIG. 7 is a cross-sectional view of a first conventional bolt-hole cover; and

FIG. 8 is a cross-sectional view of a second conventional bolt-hole cover.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

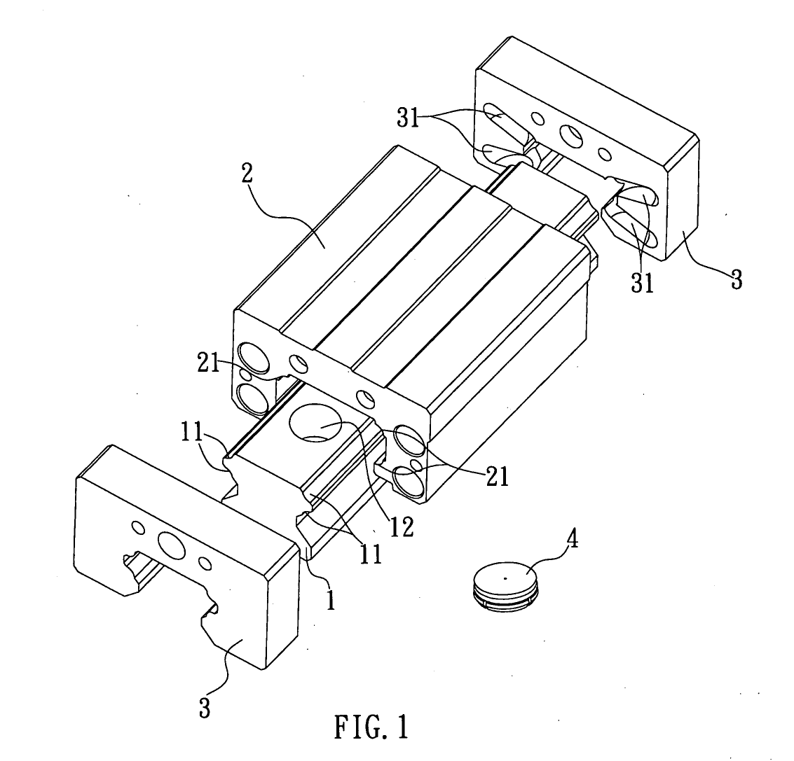

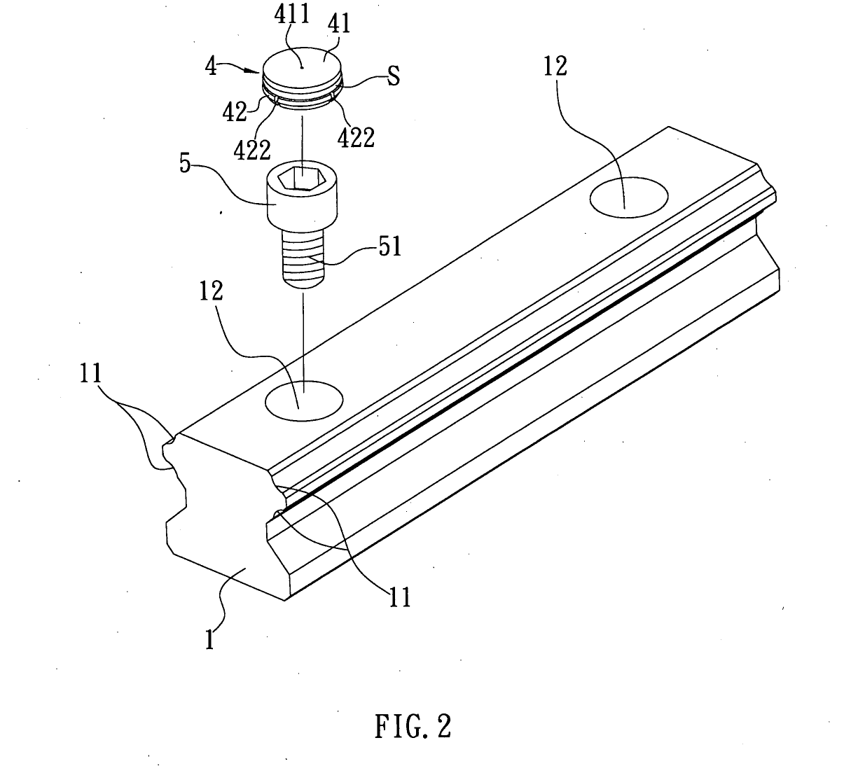

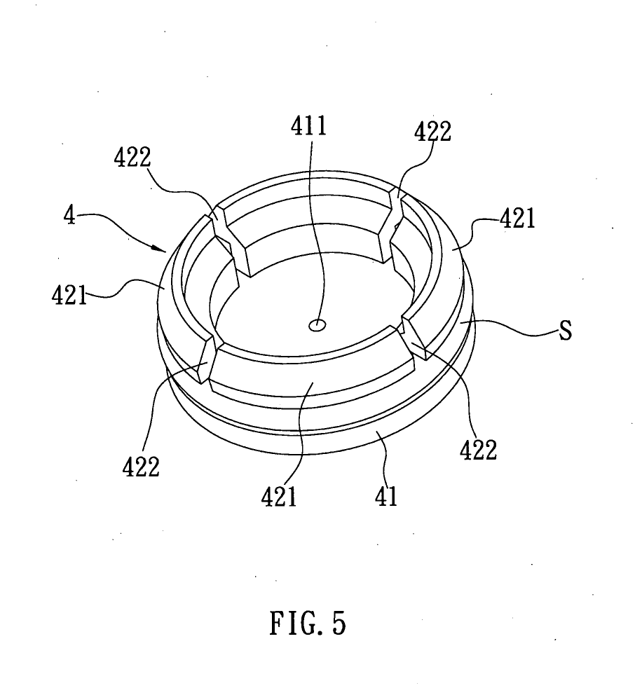

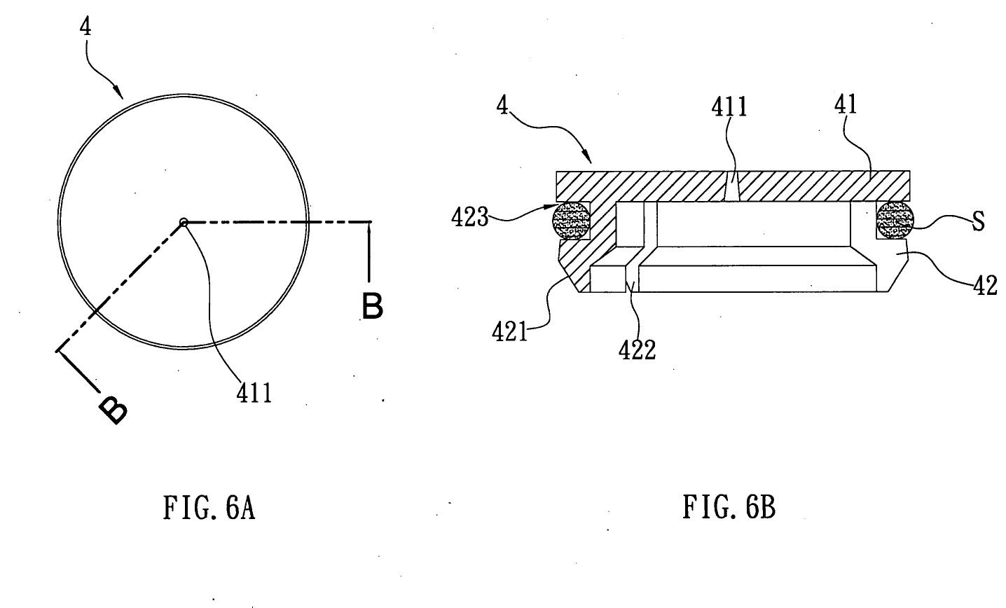

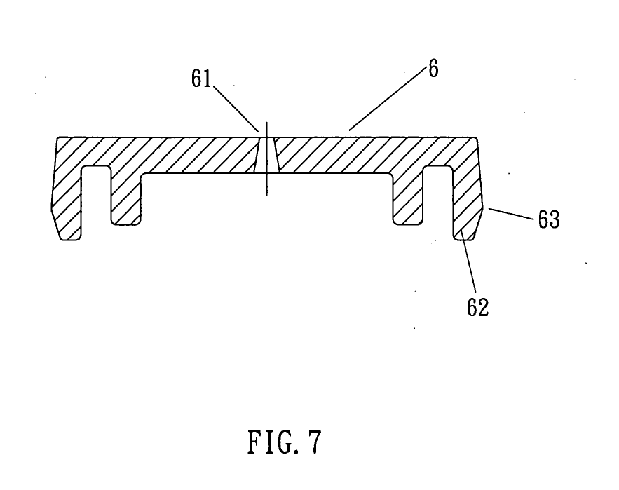

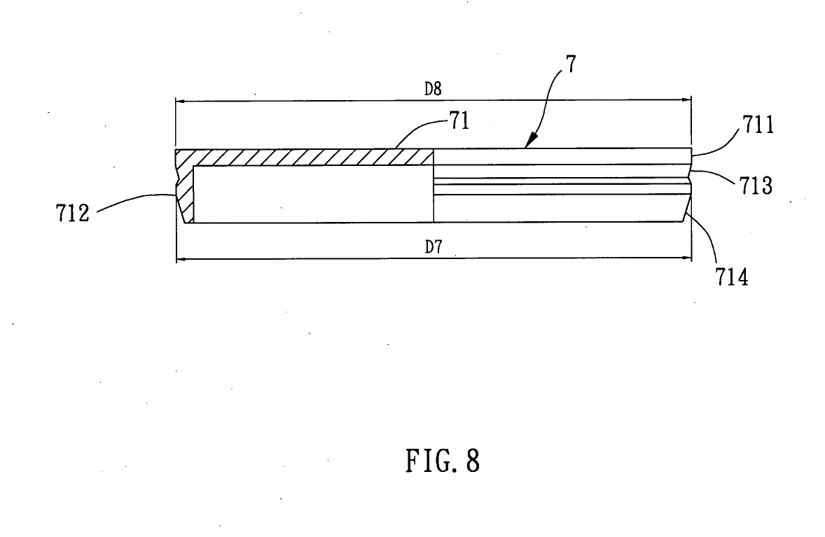

Referring to FIGS. 1-6, a linear guideway in accordance with the present invention comprises a slide rail 1, a slide block 2, plural rolling elements (not shown), two circulation members 3, plural bolts 5 and plural bolt-hole covers.

The slide rail 1 is elongated and provided with two rolling channels 11 at each of two sides thereof and plural bolt holes 12.

The slide block 2 is movably mounted on the slide rail 1 and is interiorly provided with rolling grooves 21 opposite to the rolling channels 11.

The plural rolling elements (not shown) are arranged between the rolling channels 11 and the rolling grooves 21.

The two circulation members 3 are arranged at two ends of the slide block 2 and each provided with four circulating grooves 31 for infinite circulation of the rolling elements (not shown).

The bolts 5 are inserted in the bolt holes 12 and each provided with a thread 51.

The respective bolt-hole covers essentially include a main body 4 and an elastic part S (the elastic part S can be made of a material selected from the group consisting of rubber, silica gel, thermoplastic elastomer and a metal material with an elastic coefficient smaller than that of the main body 4). The main body 4 includes a cover plate 41 and a positioning portion 42. The positioning portion 42 is arranged under the cover plate 41. The cover plate 41 is provided with a through hole 411, so that the air can be discharged from the through hole 411 when the bolt-hole cover is knocked into the bolt hole 12. The periphery of the positioning portion 42 is provided with a guiding portion 421 and a groove 423. The guiding portion 421 is an inclined surface on the outer end surface of the positioning portion 42. The guiding portion 421 has a function of guiding the bolt-hole cover into the bolt hole 12 of the slide rail 1. The positioning portion 42 is provided with plural cutting grooves 422 vertical to the cover plate 41 for dividing the positioning portion 42 into plural parts, so as to make the positioning portion 42 have flexibility.

The elastic part S is installed in the groove 423 of the positioning portion 42. The elastic part S can be round or C-shaped.

The respective bolt-hole covers essentially have three outer diameters: the first is the outer diameter D2 of the cover plate, the second is the outer diameter D3 of the positioning portion, and the third is the outer diameter D4 of the elastic part. The relation of the three outer diameters to the inner diameter D1 of the bolt hole is described below: the outer diameter D2 of the cover plate is equal to the inner diameter D1 of the bolt hole, the outer diameter D2 of the cover plate and the inner diameter D1 of the bolt hole are both smaller than the outer diameter D3 of the positioning portion, and the outer diameter D3 of the positioning portion is smaller than the outer diameter D4 of the elastic part, in other words, the outer diameter D3 is bigger than the outer diameter D2 of the cover plate and the inner diameter D1 of the bolt hole and smaller than the outer diameter D4 of the elastic part. By such arrangements, with the elastic functions of the elastic part S and the positioning portion 42, the main body 4 of the bolt-hole cover in accordance with the present invention can be fixed in the bolt hole 12 in an interference manner for preventing the bolt-hole cover from losing the dust-proof function due to disengaging from the original position.

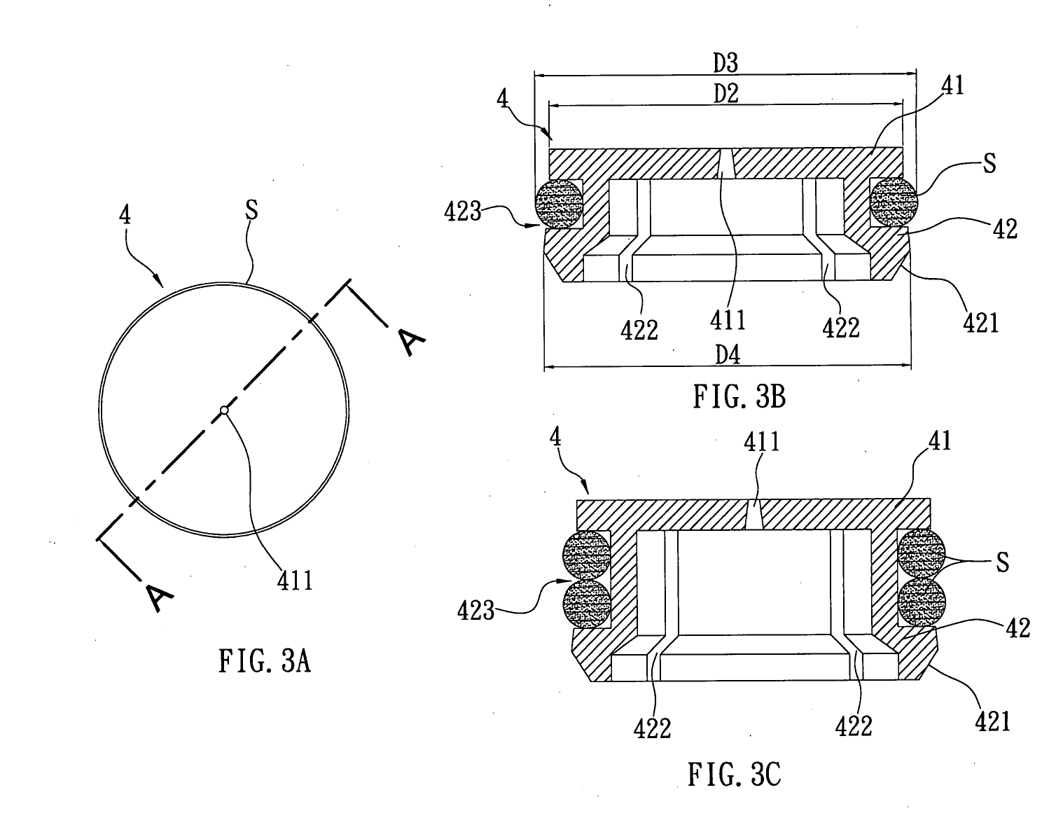

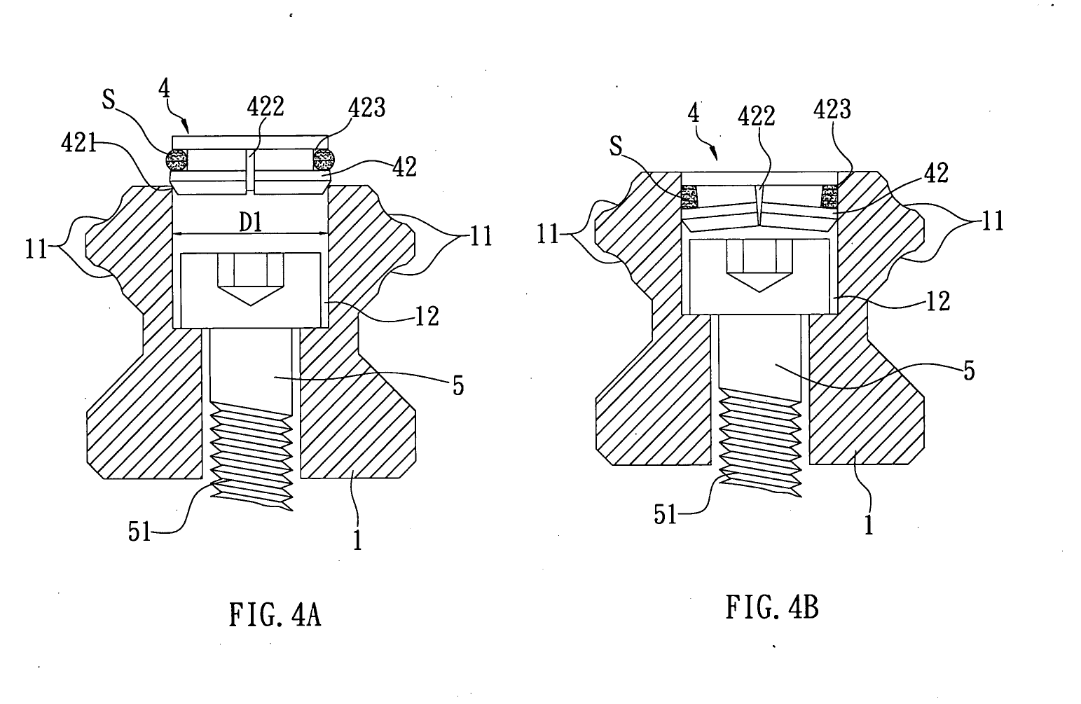

Further referring to FIG. 3C, the main body 4 of each bolt-hole cover is provided with two elastic parts S to increase the interference between the bolt-hole cover and the bolt hole 12, so that the bolt-hole can be fixed more stably. In addition, as shown in FIG. 4B illustrating how the bolt-hole cover is installed in the bolt hole 12, the positioning portion 42 has the flexibility because of the cutting grooves 422, so that when being matched with the bolt hole 12, the positioning portion 42 will be compressed by the inner diameter D1 of the bolt hole to cause deformation, and the elastic part S is also compressed to cause deformation. With the elastic functions of the positioning portion 42 and the elastic part S, after the bolt-hole cover is matched with the bolt hole 12, interference will occur between the bolt-hole cover and the bolt hole 12, so that the bolt-hole cover can be fixed more stably. Additionally, the bolt-hole cover of the present invention can be fixed stably through the interference between the elastic part and the bolt hole.

As known from the above-mentioned, the present invention has the following advantages:

1. The positioning portion 42 and the elastic part S of the present invention both have flexibility, so that the machining error of the bolt hole 12 can be absorbed.

2. With dual interference of the positioning portion 42 and the elastic part S, the positioning effect of the bolt-hole cover can be enhanced.

3. The elastic part S has replaceability, so that the elastic part S can be replaced according to different dust-proof requirements to increase the interference amount of the bolt-hole cover and the bolt hole 12.

While we have shown and described various embodiments in accordance with the present invention, it is clear to those skilled in the art that further embodiments may be made without departing from the scope of the present invention.

What is claimed is:

1. A linear guideway comprising:
a slide rail being elongated and provided with two rolling channels at each of two sides thereof and plural bolt holes;
a slide block being movable mounted on the slide rail and being interiorly provided with rolling grooves opposite to the rolling channels;
plural rolling elements being arranged between the rolling channels and the rolling grooves;
two circulation members being arranged at two ends of the slide block and each provided with four circulating grooves for circulation of the rolling elements;
plural bolts being inserted in the bolt holes and each provided with a thread; and
plural bolt-hole covers, each of the bolt-hole covers including a main body and an elastic part, the main body including a cover plate and a positioning portion, the positioning portion being arranged under the cover plate, the elastic part being provided on the positioning portion and having an elastic coefficient smaller than that of the main body, an outer diameter of the elastic part which is not fitted into the bolt hole being bigger than an inner diameter of the bolt hole, the bolt-hole cover being fixed in the bolt hole through interference of the elastic part to the bolt hole.

2. The linear guideway as claimed in claim 1, wherein a periphery of the positioning portion of the main body is provided with a groove, and the elastic part is installed in the groove of the positioning portion of the main body.

3. The linear guideway as claimed in claim 1, wherein the positioning portion is further provided with a guiding portion which is an inclined surface on an outer end surface of the positioning portion and has a function of guiding the bolt-hole cover into the bolt hole of the slide rail.

4. The linear guideway as claimed in claim 2, wherein the positioning portion is further provided with a guiding portion which is an inclined surface on an outer end surface of the positioning portion and has a function of guiding the bolt-hole cover into the bolt hole of the slide rail.

5. The linear guideway as claimed in claim 1, wherein the cover plate is provided with a through hole for discharge of air.

6. The linear guideway as claimed in claim 2, wherein the cover plate is provided with a through hole for discharge of air.

7. The linear guideway as claimed in claim 3, wherein the cover plate is provided with a through hole for discharge of air.

8. The linear guideway as claimed in claim 4, wherein the cover plate is provided with a through hole for discharge of air.

9. The linear guideway as claimed in claim 1, wherein the positioning portion is provided with plural cutting grooves vertical to the cover plate.

10. The linear guideway as claimed in claim 2, wherein the positioning portion is provided with plural cutting grooves vertical to the cover plate.

11. The linear guideway as claimed in claim 3, wherein the positioning portion is provided with plural cutting grooves vertical to the cover plate.

12. The linear guideway as claimed in claim 4, wherein the positioning portion is provided with plural cutting grooves vertical to the cover plate.

13. The linear guideway as claimed in claim 1, wherein the elastic part is round.

14. The linear guideway as claimed in claim 1, wherein the elastic part is made of a material that makes the elastic coefficient of the elastic part smaller than that of the main body.

15. The linear guideway as claimed in claim 14, wherein the elastic part is made of rubber.

16. The linear guideway as claimed in claim 14, wherein the elastic part is made of silica gel.

17. The linear guideway as claimed in claim 14, wherein the elastic part is made of thermoplastic elastomer.

18. The linear guideway as claimed in claim 1, wherein the elastic coefficient of the elastic part is made smaller than that of the main body through a shape change of the elastic part, and the elastic part produces a radial force to interfere with the bolt hole.

19. The linear guideway as claimed in claim 18, wherein the elastic part is C-shaped.

20. The linear guideway as claimed in claim 1, wherein the elastic part is integrally formed on the main body by dual material injection molding.
